(19) United States
(12) Patent Application Publication
(10) Pub. No.: US 2014/0125615 A1
(43) Pub. Date: May 8, 2014

(54) INPUT DEVICE, INFORMATION TERMINAL, INPUT CONTROL METHOD, AND INPUT CONTROL PROGRAM

(71) Applicant: PANASONIC CORPORATION, Osaka (JP)

(72) Inventors: Hiroyuki Sato, Kanagawa (JP); Tomohiro Ishihara, Kanagawa (JP)

(73) Assignee: PANSONIC CORPORATION, Osaka (JP)

(21) Appl. No.: 14/125,353

(22) PCT Filed: Oct. 10, 2012
(86) PCT No.: PCT/JP2012/006505

§ 371 Date: Dec. 11, 2013

(30) Foreign Application Priority Data
Oct. 14, 2011 (JP) 2011-227261

(51) Int. Cl. G06F 3/041; G06F 3/0354

(52) U.S. Cl. CPC G06F 3/0418; G06F 3/03545
USPC 345/173

(57) ABSTRACT

An input device includes a touch panel; a coordinate detection unit which detects coordinates of input to the touch panel; and a coordinate processing unit which performs a correction processing for detected input coordinates. In the correction processing, the coordinate processing unit corrects first coordinates input to a correction region formed on an inner side of an end portion of the touch panel to second coordinates in an input disabled region formed within the end portion of the touch panel or in the correction region, based on a distance between the input disabled region and the first coordinates.

### TECHNICAL FIELD

The present invention relates to an input device, an information terminal, an input control method and an input control program.

### BACKGROUND ART

An input device using a touch panel is generally spread. Although the touch panel is a useful tool that is able to perform an intuitive input operation, it is often difficult to perform an input operation according to a user's intention in an end portion of the touch panel. For example, there is a possibility that a hand holding an input device inadvertently touches a touch panel and thus an erroneous operation is caused. Here, the touch panel is provided on a surface of the input device.

On the other hand, a technique has been known which is able to prevent an erroneous operation by causing a perimeter frame of a touch screen to be an input disabled region (for example, see Patent Document 1). Further, a technique has been known in which the touch in a peripheral end portion of the touch panel is ignored but input is recognized as a gesture when the input with motion is detected in the peripheral end portion (for example, see Patent Document 2).

### RELATED ART DOCUMENTS

### Patent Documents

Patent Document 1: JP-P-A-2000-039964

Patent Document 2: JP-P-A-2009-217814

### SUMMARY OF THE INVENTION

### Problem to be Solved by the Invention

However, in the technique disclosed in Patent Document 1, an operation to the end portion of the touch panel on which the disabled region is to be formed is basically disabled. Further, the disabled region is set in advance and therefore operability is not sufficient. In the technique disclosed in Patent Document 2, input is disabled when a user touches one point on the end portion of the touch panel without any motion. As such, it was inevitable that the operability of the touch panel including the end portion is deteriorated.

The present invention has been made in consideration of the above circumstances, and an object thereof is to provide an input device, an information terminal, an input control method and an input control program, which are capable of improving the operability of the touch panel including an end portion formed with a disabled region.

### Means for Solving the Problem

The present invention provides an input device including: a touch panel; a coordinate detection unit which detects coordinates of input to the touch panel; and a coordinate processing unit which performs a correction processing for input coordinates detected by the coordinate detection unit; wherein, in the correction processing, the coordinate processing unit corrects first coordinates input to a correction region formed on an inner side of an end portion of the touch panel to second coordinates in an input disabled region formed within the end portion of the touch panel or in the correction region, based on a distance between the input disabled region and the first coordinates.

With this configuration, it is possible to prevent malfunction in the input disabled region formed in the end portion of the touch panel, and also possible to compensate input for the input disabled region by using the correction region. Consequently, it is possible to improve the operability of the touch panel including the end portion formed with the input disabled region.

The present invention provides an information terminal including the input device.

With this configuration, it is possible to prevent malfunction in the input disabled region formed in the end portion of the touch panel, and also possible to compensate input for the input disabled region by using the correction region. Consequently, it is possible to improve the operability of the touch panel including the end portion formed with the input disabled region.

The present invention provides an input control method including: a coordinate detection step of detecting coordinates of input to a touch panel; and a coordinate processing step of performing a correction processing for detected input coordinates, wherein, in the correction processing, the coordinate processing step is adapted to correct first coordinates input to a correction region formed on an inner side of an end portion of the touch panel to second coordinates in an input disabled region formed within the end portion of the touch panel or in the correction region, based on a distance between the input disabled region and the first coordinates.

With this method, it is possible to prevent malfunction in the input disabled region formed in the end portion of the touch panel, and also possible to compensate input for the input disabled region by using the correction region. Consequently, it is possible to improve the operability of the touch panel including the end portion formed with the input disabled region.

The present invention provides an input control program for causing a computer to execute each step of the input control method.

With this program, it is possible to prevent malfunction in the input disabled region formed in the end portion of the touch panel, and also possible to compensate input for the input disabled region by using the correction region. Consequently, it is possible to improve the operability of the touch panel including the end portion formed with the input disabled region.

### Advantages of the Invention

According to the present invention, it is possible to improve the operability of the touch panel including the end portion formed with the input disabled region.

### BRIEF DESCRIPTION OF THE DRAWINGS

FIG. 1 is a block diagram showing a configuration example of an input device in a first embodiment of the present invention.

FIG. 2 is a schematic view showing each region of a normal region, a correction region and an input disabled region of a touch panel in the first embodiment of the present invention.

FIG. 3(A) to 3(C) is a view showing an example of a change in a detectable region of the input device when being gripped in the first embodiment of the present invention.

FIG. 4 is a view showing an image of a correction processing in the first embodiment of the present invention.

FIG. 5 is a view showing an arrangement example of each region of the normal region, the correction region and the input disabled region of the touch panel in the first embodiment of the present invention.

FIG. 6(A) to 6(C) is a view showing an example of a change of the coordinates before and after the correction processing in the first embodiment of the present invention.

FIG. 7 is a view showing an example of the relationship between the coordinates on the touch panel and the correction coefficient in the first embodiment of the present invention.

FIG. 8 is a flow chart showing an operation example of the input device in the first embodiment of the present invention.

FIG. 9 is a block diagram showing a configuration example of an input device in a second embodiment of the present invention.

FIG. 10 is a view showing an example of a hover detection region in the second embodiment of the present invention.

FIG. 11 is a flow chart showing an operation example of the input device in the second embodiment of the present invention.

FIG. 12 is a block diagram showing a configuration example of an input device in a third embodiment of the present invention.

FIG. 13 is a flow chart showing an operation example of the input device in the third embodiment of the present invention.

### MODE FOR CARRYING OUT THE INVENTION

Hereinafter, illustrative embodiments of the present invention will be described with reference to the drawings.

An input device of the present embodiment widely includes an input device using a touch panel. Further, the input device can be mounted to a variety of mobile electronic equipments such as a mobile phone, a smart phone, a tablet terminal and an information terminal such as a mobile information terminal, a car navigation device.

### First Embodiment

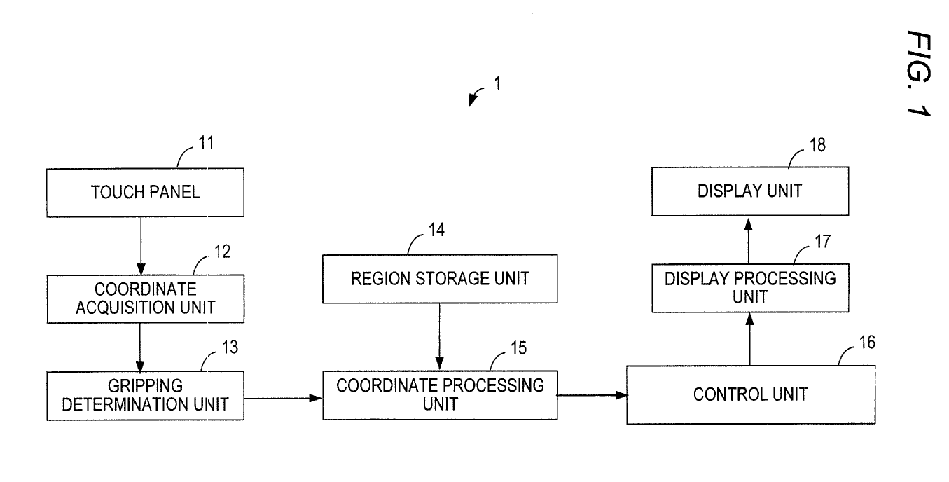

FIG. 1 is a block diagram showing a configuration example of an input device 1 in a first embodiment of the present invention. The input device 1 includes a touch panel 11, a coordinate acquisition unit 12, a gripping determination unit 13, a region storage unit 14, a coordinate processing unit 15, a control unit 16, a display processing unit 17 and a display unit 18.

The touch panel 11 is provided in a screen of the display unit 18 and includes an internal memory, a control IC, a sensor, etc. Further, the touch panel 11 detects an input using a finger or a stylus pen. Meanwhile, the touch panel 11 may be an arbitrary type including a resistive touch panel or a capacitive touch panel, etc. Herein, the case of using the capacitive touch panel is mainly described. Further, in the present embodiment, the touch panel may be a two-dimensional touch panel to detect two-dimensional orthogonal coordinates (xy coordinates) or a three-dimensional touch panel (proximity touch panel) to detect three-dimensional orthogonal coordinates (xyz coordinates).

When an input is executed by an input means such as a user's finger or a stylus pen, a sensor output (for example, the amount of change in capacitance) in the vicinity of an input position becomes larger than sensor outputs at the other positions. As the sensor output becomes larger than a predetermined value, the touch panel 11 detects that the input means is in contact with a surface (touch panel surface) of the touch panel 11 or the input means is approaching the touch panel 11.

Further, in the touch panel 11, coordinates corresponding to the sensor output are calculated as input coordinates by the control IC and a contact area is also calculated from the sensor output. The input coordinates to be calculated are xy coordinates or xyz coordinates. In addition, the calculated coordinates and contact area are stored in an internal memory of the touch panel 11.

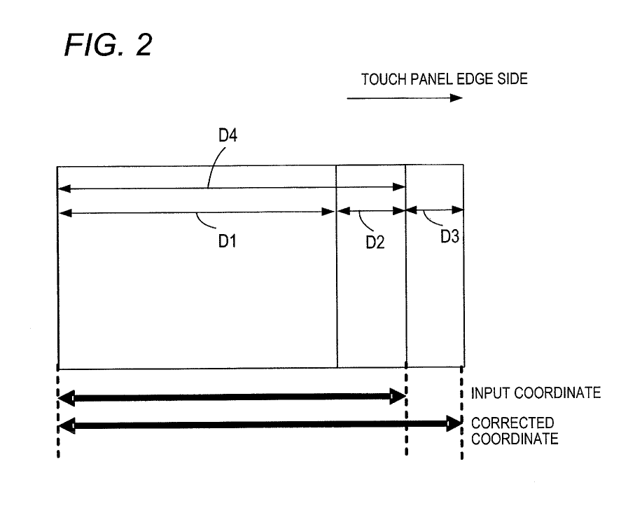

Further, as shown in FIG. 2, the touch panel 11 is formed with a normal region D1, a correction region D2 and an input disabled region D3 in order to properly process the coordinates of the input to the touch panel 11. FIG. 2 is a schematic view showing respective regions on the touch panel 11.

The input disabled region D3 is formed on an end portion 11e of the touch panel 11 when a predetermined condition is satisfied and the input to the input disabled region is disabled. The correction region D2 is formed on the inside (the center side of the touch panel 11) of the end portion 11e of the touch panel 11 when a predetermined condition is satisfied and the input to the correction region is corrected. The normal region D1 is a region in which a special processing such as the disablement or correction is not performed for the coordinates of the input to the touch panel 11. Further, the normal region D1 and the correction region D2 are configured as a detectable region D4. That is, the input to the normal region and the correction region can be detected.

The coordinate acquisition unit 12 reads out (acquires) the input coordinates from the touch panel 11. That is, the coordinate acquisition unit 12 detects (acquires) the coordinates of the input to the touch panel 11.

The gripping determination unit 13 determines whether the input device 1 is gripped by a user or not. For example, the following three methods are considered as a gripping determination method.

(1) When input to both end portions of the input device in the lateral direction (x direction) or both end portions of the input device in the vertical direction (y direction) is detected by the touch panel 11 and also input is detected above a predetermined range (a predetermined area) in at least one end portion of the input device, it is determined that the input device is gripped by hand. The reason is that the input is considered due to a plurality of fingers of a user when the input is detected at a relatively wide range in the end portion 11e of the touch panel 11.

(2) When input to both end portions of the input device in the lateral direction (x direction) or both end portions of the input device in the vertical direction (y direction) is detected by the touch panel 11 and it is also detected that a plurality of sensor outputs at predetermined that the input device is gripped by hand surroundings thereof, it is determined that the input device is gripped by hand. The reason is that the portions of the end portion 11e of the touch panel 11 which have a relatively high sensor output is considered due to a plurality of fingers of a user.

(3) The touch panel 11 is provided in a front surface of a casing of the input device 1 and a sensor is separately provided on a side surface of the casing, rather than the front surface or a back surface of the casing. When an object is detected in the vicinity of the sensor by the sensor on the side surface, it is detected that the input device is gripped by hand.

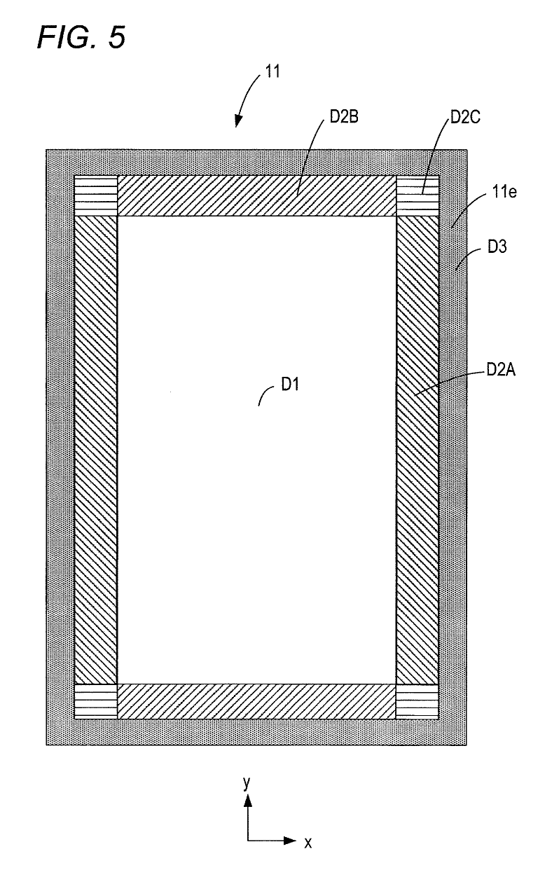

Parameters such as the coordinate information for a placement position of the correction region D2 and a placement position of the input disabled region D3 in the touch panel 11 are stored in advance in the region storage unit 14. For example, the parameters are held so that respective regions in the touch panel 11 are arranged as shown in FIG. 5 (which will be described later). Meanwhile, instead of maintaining the parameters of respective regions in advance, the placement positions of respective regions may be set dynamically. For example, the coordinate processing unit 15 may disable the region up to the innermost coordinates of the touch panel 11 among the consecutive input coordinates to the end portion 11e of the touch panel 11.

When it is determined by the gripping determination unit 13 that the input device is gripped, the coordinate processing unit 15 is adapted to form the input disabled region D3 and the correction region D2 at the placement positions represented by the parameters stored in the region storage unit 14.

Further, when input to the input disabled region D3 is performed in a state where the input disabled region D3 is formed, the coordinate processing unit 15 performs a disabling processing to disable the input. That is, in the disabling processing, the coordinate processing unit 15 validates a third coordinates input in the input disabled region D3. In the disabling processing, the coordinate processing unit 15 stops outputting the input coordinates acquired by the coordinate acquisition unit 12 to the control unit 16, depending on the input to the input disabled region D3.

Further, when input to the correction region D2 is performed in a state where the correction region D2 is formed, the coordinate processing unit 15 performs a correction processing to correct the input coordinates of the input. In the correction processing, the coordinate processing unit 15 corrects the input coordinates (first coordinates) acquired by the coordinate acquisition unit 12 in accordance with input to the correction region D2 to a second coordinates in the region of the correction region D2 and the input disabled region D3 based on the distance (that is, the distance between the end portion 11e of the touch panel 11 and the first coordinates) between the input disabled region D3 and the first coordinates. In this case, the correction processing is performed in such a way that the distance between an edge of the touch panel 11 and a second coordinates becomes shorter as the distance between the input disabled region D3 and the first coordinates becomes shorter. With this correction processing, the input to the correction region D2 is extended and handled, similarly to the input to the input disabled region D3 side. Accordingly, the input to the correction region D2 can be handled in the same way as the input to the input disabled region D3. Details of the correction processing will be described later.

Further, the coordinate processing unit 15 does not perform a special processing for the input to the normal region D1. Specifically, the coordinate processing unit 15 outputs the input coordinates acquired by the coordinate acquisition unit 12 in response to the input to the normal region D1 as it is to the control unit 16. When the input disabled region D3 and the correction region D2 are formed, the normal region D1 refers to a region on the touch panel other than these regions D3 and D2. In addition, when the input disabled region D3 and the correction region D2 are not formed (when the input device 1 is not gripped, in the present embodiment), the normal region refers to an entire region on the touch panel 11.

The control unit 16 manages an entire operation of the input device 1 and performs various controls based on the coordinates output from the coordinate processing unit 15. For example, the control unit performs a processing related to various operations (gestures) such as a touch operation, a double-tap operation, a drag operation, a pinch-out operation (enlargement operation) and a pinch-in operation (reduction operation) and a processing of various applications, etc.

The display processing unit 17 performs a processing related to the display by the display unit 18 in accordance with the various controls by the control unit 16.

The display unit 18 is a display device such as a LCD (Liquid Crystal Display) and is adapted to display a variety of information on the screen, in response to the instructions of the display processing unit 17.

Here, the functions of the coordinate acquisition unit 12, the gripping determination unit 13, the coordinate processing unit 15, the control unit 16 and the display processing unit 17 may be realized by a dedicated hardware circuit or by a software control by a CPU.

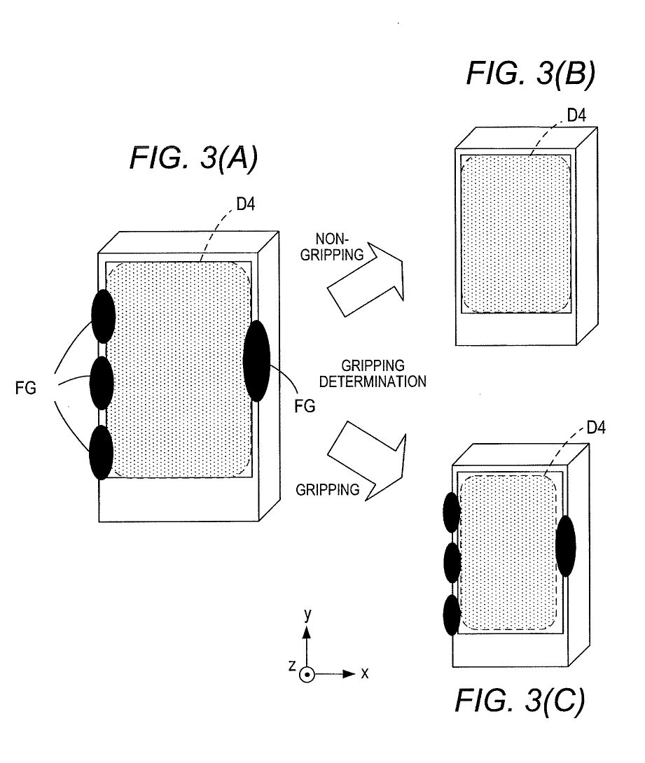

Next, a change in the detectable region D4 of the casing of the input device 1 when being gripped will be described. FIG. 3(A) to 3(C) is a view showing an example of the change in the detectable region D4 of the input device 1 when being gripped.

Before it is determined by the gripping determination unit 13 that the input device 1 is gripped, an entire surface of the touch panel 11 is configured as the detectable region D4, as shown in FIG. 3(A). In this state, when the input device 1 is gripped by a user, fingers FG of the user appear in the left and right end portions of FIG. 3 and are overlapped with the detectable region D4 in the xy plane, as shown in FIG. 3(A). When this condition is continued, the fingers FG are detected by the touch panel 11 and thus there is a possibility that an erroneous input occurs.

When it is determined by the gripping determination unit 13 that the input device 1 is not gripped, the size of the detectable region D4 is not changed and the same as in FIG. 3(A), as shown in FIG. 3(B).

On the other hand, when it is determined by the gripping determination unit 13 that the input device 1 is gripped, the coordinate processing unit 15 is adapted to form the input disabled region D3 and the correction region D2. Then, as shown in FIG. 3(C), the detectable region D4 is changed to a region excluding the input disabled region D3 and therefore the size of the detectable region D4 is reduced. Thereby, it is possible to prevent occurrence of an erroneous input by fingers FG of the user gripping the input device 1.

Next, details of the correction processing are described.

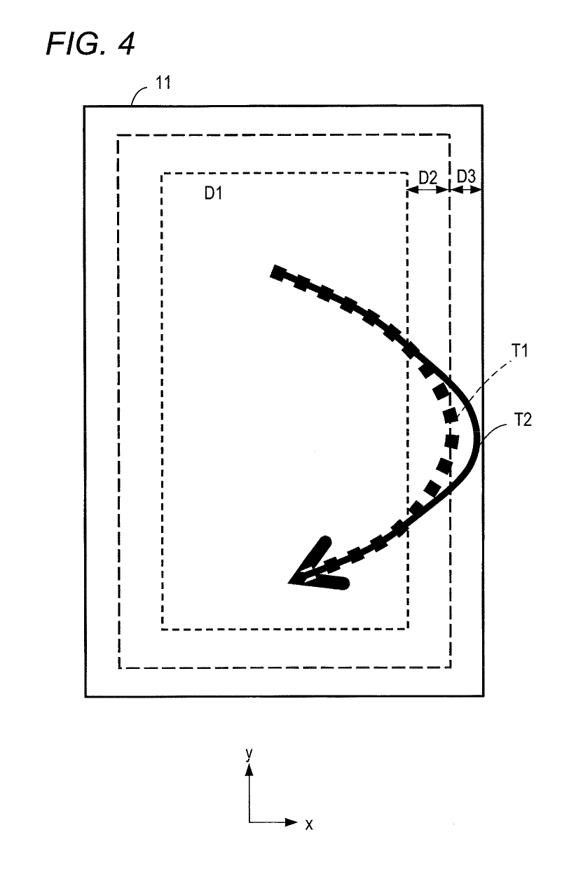

FIG. 4 is a view showing an image of the correction processing. As described previously, when a user draws a trajectory T1 on the touch panel 11 with an input means such as a user's finger in a state where the correction region D2 and the input disabled region D3 are formed on the touch panel 11, the coordinates of the trajectory T1 are acquired by the coordinate acquisition unit 12. The coordinate processing unit 15 does not perform a correction processing for the portion of the trajectory T1 contained in the normal region D1 but performs a correction processing for the portion of the trajectory contained in the correction region D2. As a result, the trajectory T1 is changed to a trajectory T2 and the trajectory T2 is displayed in the screen of the display unit 18. Accordingly, the trajectory T2 is displayed as a pointer display, for example. In this way, although the input to the input disabled region D3 is disabled, operation can be performed up to the end portion 11e of the touch panel 11.

FIG. 5 is a view showing an arrangement example of each region to be formed on the touch panel 11. The end portion 11e of the touch panel 11 is formed with the input disabled region D3. FIG. 5 illustrates an example where the input disabled region D3 is formed over an entire peripheral end portion of the touch panel 11. The correction region D2 (D2A to D2c) is formed at a predetermined region on the inside of the end portion 11e of the touch panel 11. The correction region D2A is a region adjacent to the end portion 11e in “x” direction. The correction region D2B is a region adjacent to the end portion 11e in “y’ direction perpendicular to “x” direction. The correction region D2C is a region adjacent to both the end portion 11e in “x” direction and the end portion 11e in “y” direction. The normal region D1 is formed on the inside (center side of the touch panel 11) of the correction region D2.

In the present embodiment, the coordinate processing unit 15 is adapted to form the correction region D2 and the input disabled region D3 when it is determined by the gripping determination unit 13 that the input device 1 is gripped. Accordingly, the disabling processing and the correction processing are performed only when the input device is gripped. By doing so, it is possible to prevent the occurrence of an erroneous input and to improve the deterioration of the operability. Furthermore, it is possible to maintain normal operability when the input device is not gripped.

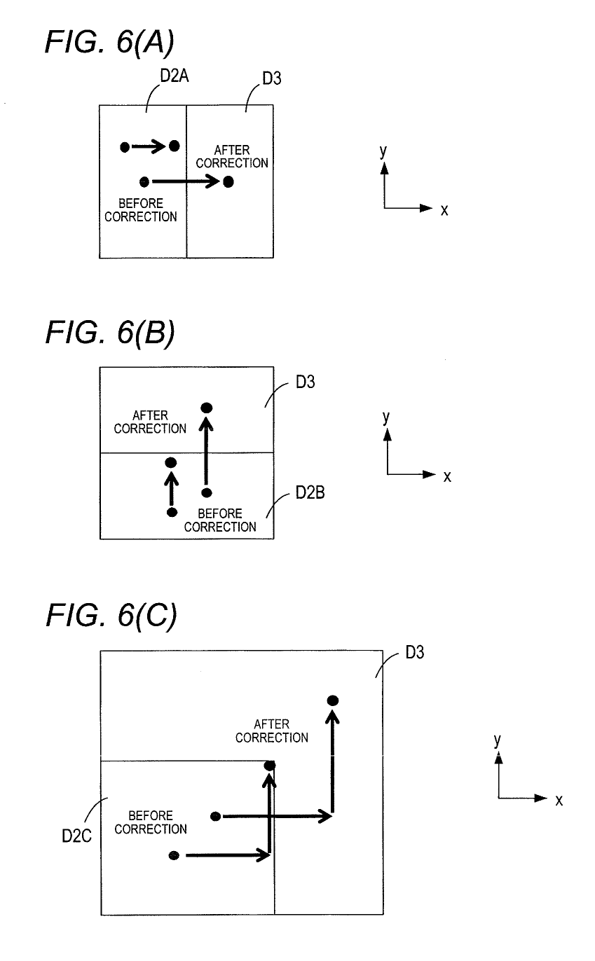

When input to the correction region D2A is performed in a state where the correction region D2A is formed, the coordinates of the input is corrected toward the end portion 11e in “x” direction, i.e., toward the input disabled region D3, as shown in FIG. 6(A). That is, the coordinate processing unit 15 corrects “x” coordinate of the input coordinates so as to approach the edge of the touch panel 11.

When input to the correction region D2B is performed in a state where the correction region D2B is formed, the coordinates of the input is corrected toward the end portion 11e in “y” direction, i.e., toward the input disabled region D3, as shown in FIG. 6(B). That is, the coordinate processing unit 15 corrects “y” coordinate of the input coordinates so as to approach the edge of the touch panel 11.

When input to the correction region D2C is performed in a state where the correction region D2C is formed, the coordinates of the input is corrected toward the end portion 11e in “xy” direction, i.e., toward the input disabled region D3, as shown in FIG. 6(C). That is, the coordinate processing unit 15 corrects “x” coordinate and “y” coordinate of the input coordinates so as to approach the edge of the touch panel 11.

In this way, the coordinate processing unit 15 may correct the first coordinates input to the correction region D2 (correction region D2A, D2B or D2C) formed on the side of the end portion 11e of the touch panel 11 in a first direction (“x” direction, “y” direction or “xy” direction) to the second coordinates in the input disabled region D3 formed on the end portion 11e in the first direction or the correction region D2 formed on the side of the end portion 11e in the first direction. As a result, it is possible to prevent the occurrence of an erroneous input by disabling the input to the input disabled region D3 and further it is possible to substitute the input to the input disabled region D3 on the end portion in the first direction by using the correction region D2A, D2B or D2C.

In the correction processing, the coordinate processing unit 15 calculates coordinates after correction by multiplying a correction coefficient “α” to coordinates before correction, i.e., the input coordinates acquired by the coordinate acquisition unit 12, for example. For example, when it is assumed that a reference coordinates (0, 0) is present in the normal region D1, the correction coefficient “α” is larger than 1 (α>1). Since the correction coefficient “α” is larger than 1 (α>1), the coordinate value after correction is increased and therefore the input coordinates in the correction region D2 can be corrected to the coordinates in the input disabled region D3.

Further, the coordinate processing unit 15 multiplies the correction coefficient “α” only to “x” coordinate of the input coordinates, for the input to the correction region D2A. The coordinate processing unit 15 multiplies the correction coefficient “α” only to “y” coordinate of the input coordinates, for the input to the correction region D2B. The coordinate processing unit 15 multiplies the correction coefficient “α” to both “x” coordinate and “y” coordinate of the input coordinates, for the input to the correction region D2C.

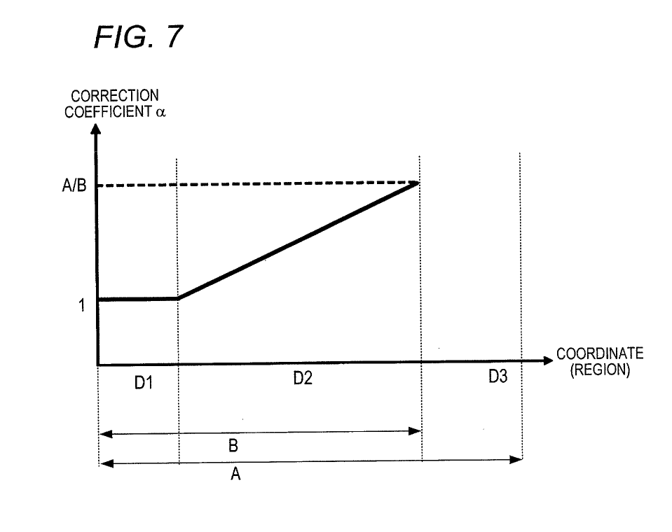

FIG. 7 is a view showing an example of the relationship between the coordinates on the touch panel 11 and the correction coefficient “α”. In the normal region D1, the correction coefficient “α” is equal to 1 (“α”=1) and kept constant. That is, the input coordinates is sent as it is to the control unit 16. In the correction region D2, the correction coefficient “α” is increased at a certain amount of change from the normal region D1 side to the input disabled region D3 side. In the input disabled region D3, the correction processing is not performed and input to the input disabled region is disabled.

For example, a distance between the reference coordinates in the normal region D1 and coordinates of boundary of the correction region D2 and the input disabled region D3 is defined as “B” and a distance between the reference coordinates in the normal region D1 and an outermost coordinates (coordinates of edge of the touch panel 11) of the correction region D2 and the input disabled region D3 is defined as “A”. In an example of the correction coefficient “α” in the correction region D2 of FIG. 7, the correction coefficient “α” is equal to “1” at the coordinates of boundary of the normal region D1 and the correction region D2 and the correction coefficient “α” is equal to “A/B” at the coordinates of boundary of the correction region D2 and the input disabled region D3. Between these coordinates, the correction coefficient 37 α” is changed from “1” to “A/B” at a certain amount of change.

In this way, in the example of FIG. 7, the resolution in the correction region D2 is gradually increased toward the input disabled region D3. And, the correction coefficient “α” is adjusted in such a way that the coordinates after correction becomes the outermost coordinates of the input disables region D3, i.e., the coordinates of edge of the touch panel 11 when reaching the outermost side of the correction region D2, i.e., the boundary of the correction region and the input disabled region D3. With the resolution being gradually increased, a rapid change of coordinates from the normal region D1 is alleviated and therefore it is possible to draw the trajectory T2 (see FIG. 4) as natural as possible.

Meanwhile, although it is desirable that the correction coefficient “α” is changed as shown in FIG. 7, the correction coefficient “α” (α>1) may be set to be unchanged in each coordinate of the correction region D2. Further, instead of using the correction coefficient, a mapping table may be used in the correction processing. Here, the mapping table stores parameters to associate the coordinate before correction with the coordinate after correction and is stored in advance in the region storage unit 14.

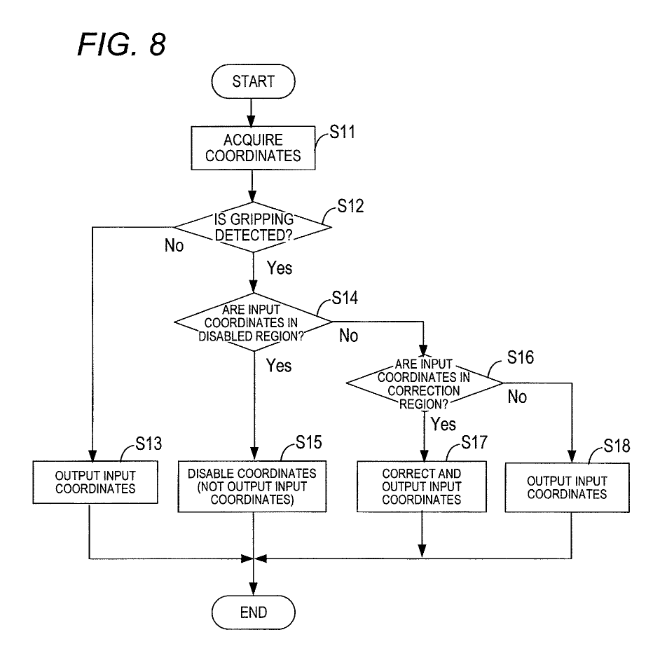

Next, an operation of the input device 1 is described. FIG. 8 is a flow chart showing an operation example of the input device 1. An input control program for performing this operation is stored in ROM within the input device 1 and executed by CPU within the input device 1.

First, the coordinate acquisition unit 12 acquires the input coordinates based on the sensor output of the touch panel 11 (Step S11).

Subsequently, the gripping determination unit 13 determines whether the input device 1 is gripped by a user, based on the sensor output of the touch panel 11 (Step S12).

When it is determined in Step S12 that the input device 1 is not gripped, the coordinate processing unit 15 outputs the input coordinates from the coordinate acquisition unit 12 as it is to the control unit 16 (Step S13). That is, the coordinate processing unit does not perform a special processing such as a disabling processing or a correction processing for the input coordinates. In this case, the input disabled region D3 and the correction region D2 are formed, so that the normal region D1 is provided over an entire surface of the touch panel 11.

When it is determined in Step S12 that the input device 1 is gripped, the coordinate processing unit 15 is adapted to form each region. Specifically, the coordinate processing unit 15 is adapted to form the normal region D1, the correction region D2 and the input disabled region D3 on the touch panel 11. And, the coordinate processing unit 15 determines whether the input coordinates corresponds to the coordinates within the input disabled region D3 or not (Step S14). This input coordinates is equivalent to the input which has been unconsciously performed at the time of gripping, for example.

When it is determined in Step S14 that the input coordinates corresponds to the coordinates within the input disabled region D3, the coordinate processing unit 15 performs a disabling processing to disable the input coordinates (Step S5). That is, the coordinate processing unit 15 does not output the input coordinates to the control unit 16 but discards the input coordinates.

When it is determined in Step S14 that the input coordinates does not correspond to the coordinates within the input disabled region D3, the coordinate processing unit 15 determines whether the input coordinates corresponds to the coordinates within the correction region D2 or not (Step S16).

When it is determined in Step S16 that the input coordinates corresponds to the coordinates within the correction region D2, the coordinate processing unit 15 performs a correction processing for the input coordinates and outputs the result thereof to the control unit 16 (Step S17). For example, when a set of the input coordinates draws the trajectory T1 shown in FIG. 4, the set of the input coordinates is converted to the set of coordinates such as the trajectory T2 by the correction processing. This input coordinates is equivalent to the input which is intentionally performed, separately from the input which is unconsciously performed when gripping the input device.

When it is determined in Step S16 that the input coordinates does not correspond to the coordinates within the correction region D2, the coordinate processing unit 15 outputs the input coordinates as it is to the control unit 16 (Step S18). That is, the coordinate processing unit does not perform a special processing such as a disabling processing or a correction processing for the input coordinates. In this case, the input coordinates corresponds to the coordinates within the normal region D1.

According to the input device 1 of the present embodiment, it is possible to prevent malfunction due to an erroneous input to the end portion 11e of the touch panel 11 when the input device 1 is gripped. Particularly, although the touch panel 11 is progressing toward the narrow frame (miniaturization) in recent years, it is possible to prevent malfunction. On the other hand, when the input device is not gripped by a user, for example, when the input device is placed on a desk, the input disabled region D3 or the correction region D2 is not provided and therefore it is possible to prevent the operability of the touch panel 11 from being impaired. Accordingly, it is possible to improve the operability of the touch panel 11 in which the end portion 11e is formed with the input disabled region D3.

### Second Embodiment

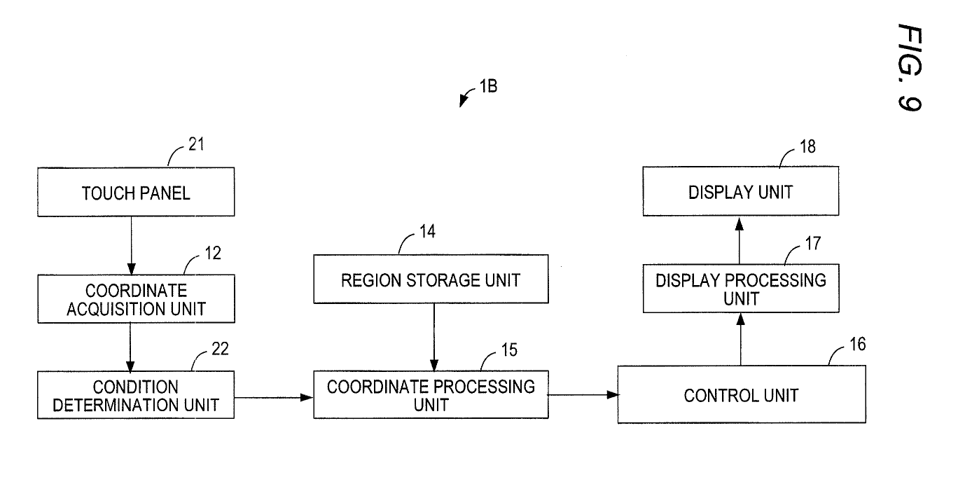

FIG. 9 is a block diagram showing a configuration example of an input device 1B in a second embodiment of the present invention. The same parts of the input device 1B as those of the input device 1 described in the first embodiment will be denoted by the same reference numeral as those of the input device 1 shown in FIG. 1 and a description of the same or similar parts will be omitted or simplified.

The input device 1B includes a touch panel 21 instead of the input touch panel 11 and a condition determination unit 22 instead of the gripping determination unit 13.

The touch panel 21 is different from the touch panel 11 in that the touch panel 21 is limited to a three-dimensional touch panel to detect three-dimensional orthogonal coordinates (xyz coordinates). Although an example where the touch panel 21 is a capacitive touch panel will be described in the present embodiment, the touch panel may be any other type touch panel.

The condition determination unit 22 is different from the gripping determination unit 13 in that the condition determination unit 22 determines whether an input means such as a finger or a stylus pen is in a hover state (will be described later) or not. Here, the determination of gripping is performed by the condition determination unit 22.

When a sensor output (for example, an amount of change in capacitance) of the touch panel 21 is equal to or greater than a first predetermined value, the condition determination unit 22 detects that an input means such as a finger is in a state (a touched state) of being in contact with or pressed on a touch panel surface 21a. Further, when a predetermined condition that the sensor output of the touch panel 21 is smaller than the first predetermined value is satisfied, the condition determination unit 22 detects that the input means such as the finger is in a state (a hover state) of being close to a position slightly spaced apart from the touch panel surface 21a. Since the input means in the hover state is further spaced apart from the touch panel surface 21a than in the touched state, the sensor output of the touch panel 21 becomes smaller when the input means is in the hover state.

Meanwhile, the functions of the condition determination unit 22 may be realized by a dedicated hardware circuit or by a software control by a CPU.

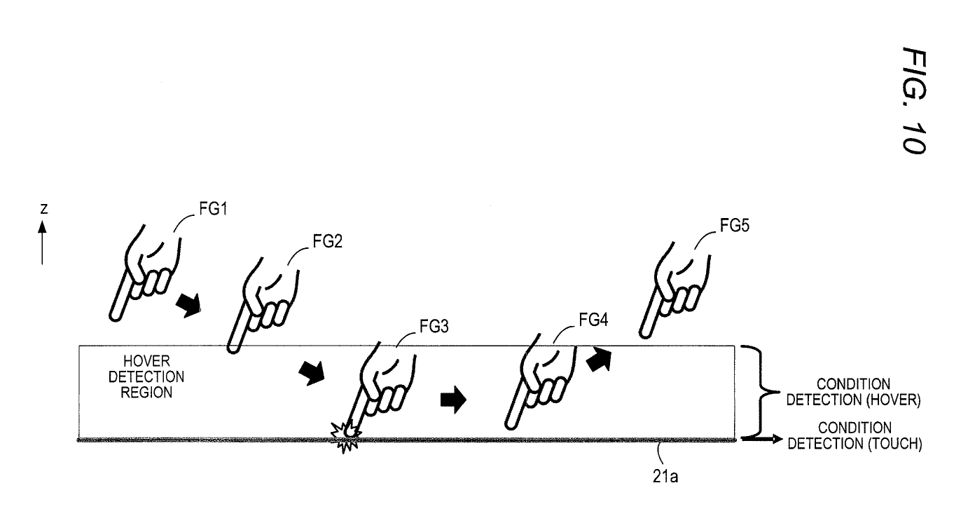

FIG. 10 is a view showing an example of the hover state and the touched state. In FIG. 10, the fingers FG1 to FG5 of a user are illustrated in a state of moving from the finger FG1 toward the finger FG5 over time. The finger FG3 touching to the touch panel surface 21a is detected as the touched stated. In FIG. 10, a position of the touch panel surface 21a is set as a reference point in which “z” is equal to “0”. Z coordinate represents a coordinate in a direction (“z” direction) perpendicular to the touch panel surface 21a (xy plane). Specifically, when “z”=1 is acquired by the coordinate acquisition unit 12, the condition determination unit 22 detects that the finger FG3 is in the touched state.

Further, in FIG. 10, when a relationship of 0<z≦zth is acquired by the coordinate acquisition unit 12, it is determined by the condition determination unit 22 that the input means is in the hover state. In FIG. 10, the region to be detected as the hover state is indicated as a hover detection region. In the example shown in FIG. 10, it is detected that the finger FG2 and the finger FG4 are in the hover state.

On the other hand, instead of setting the hover detection region as a region having a predetermined width in “z” direction as shown in FIG. 10, the condition determination unit 22 may determination that the input means is in the hover state only when “z” coordinate is equal to a second predetermined value to satisfy the relationship of 0<z≦zth, for example.

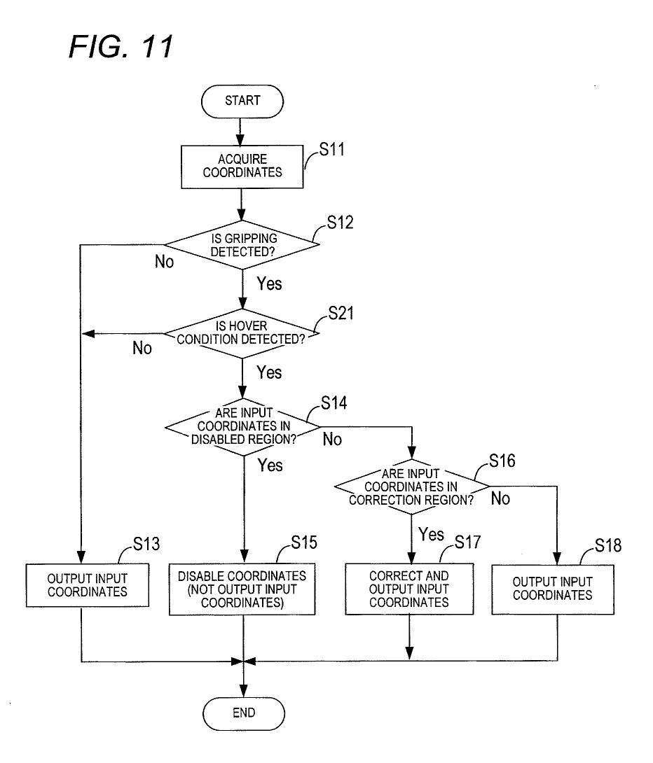

Next, an operation of the input device 1B is described. FIG. 11 is a flow chart showing an operation example of the input device 1B. An input control program for performing this operation is stored in ROM within the input device 1B and executed by CPU within the input device 1B. In FIG. 11, a description of the same steps as the steps described in FIG. 8 will be omitted or simplified.

When it is detected in Step S12 that the input device 1B is gripped, the condition determination unit 22 determines whether an input means such as a finger to perform input to the touch panel 21 is in the hover state or not (Step S21). When it is determined in Step S21 that the input means is in the hover state, the input device 1B is adapted to proceed the processing of Step S14.

When it is detected in Step S12 that the input device 1B is not gripped or when it is detected in Step S21 that the input means is not in the hover state, the input device 1B is adapted to proceed the processing of Step S13.

Accordingly, only when the input means is in the hover state, the coordinate processing unit 15 is adapted to form the correction region D2 and the input disabled region D3 on the touch panel 21 and performs the input disabling processing or the correction processing, depending on the input coordinates. On the contrary, when the input means is not in the hover state, the whole of the touch panel 21 remains as the normal region D1 even when the touched state is detected. Accordingly, a normal input operation can be performed.

In this way, the coordinate processing unit 15 is adapted to form the input disabled region D3 and the correction region D2 when the coordinates of the input to the touch panel 21 in a direction (“z” direction) perpendicular to the touch panel surface 21a corresponds to the coordinates in a predetermined range of non-contact with the touch panel 21.

It is thought that the input device 1B is more likely to detect the hover state when a user grasps the input device 1B with his hand. According to the input device 1B of the present embodiment, since the disabling processing and the correction processing for input to the end portion are performed only when the hover state is detected in the end portion of the touch panel 21, it is possible to perform a special processing only when there is a higher possibility of gripping. Further, it is possible to reduce an erroneous input by detecting the hover state at the time of gripping the input device 1B. Otherwise, it is possible to maintain the normal operability. Accordingly, it is possible to improve the operability of the touch panel 21 in which the end portion is formed with the input disabled region D3.

### Third Embodiment

In the present embodiment, it is not assumed that a user grasps the input device 1. Further, it is assumed that a stylus pen is used as the input means. In the case of the stylus pen, the sensor output of the touch panel 11 is small and non-detection is likely to occur in the end portion “11e of the touch panel 11, as compared to an input means such as a finger which has a relatively large touch area or hover area (hereinafter, also referred to as “input area”). Therefore, when the input means is a stylus pen, the input disabled region D3 and the correction region D2 are formed and the disabling processing and the correction processing for input to the touch panel 11 are performed as necessary, as in the first embodiment.

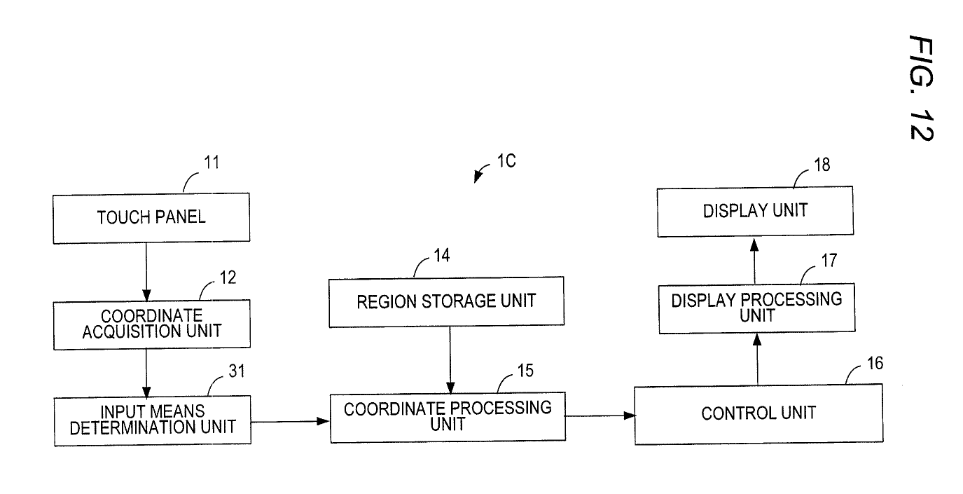

FIG. 12 is a block diagram showing a configuration example of an input device 1C in a third embodiment of the present invention. The same parts of the input device 1C as those of the input device 1 described in the first embodiment will be denoted by the same reference numeral as those of the input device 1 shown in FIG. 1 and a description of the same or similar parts will be omitted or simplified.

The input device 1C includes an input means determination unit 31 instead of the gripping determination unit 13. The input means determination unit 31 determines whether the input means is a stylus pen or not. For example, the input means determination unit 31 determines that the input means is the stylus pen when an input area detected by the touch panel 11, i.e., the spread of the input coordinate group acquired by the coordinate acquisition unit 12 is equal to or less than a predetermined range.

Meanwhile, the functions of the input means determination unit 31 may be realized by a dedicated hardware circuit or by a software control by a CPU.

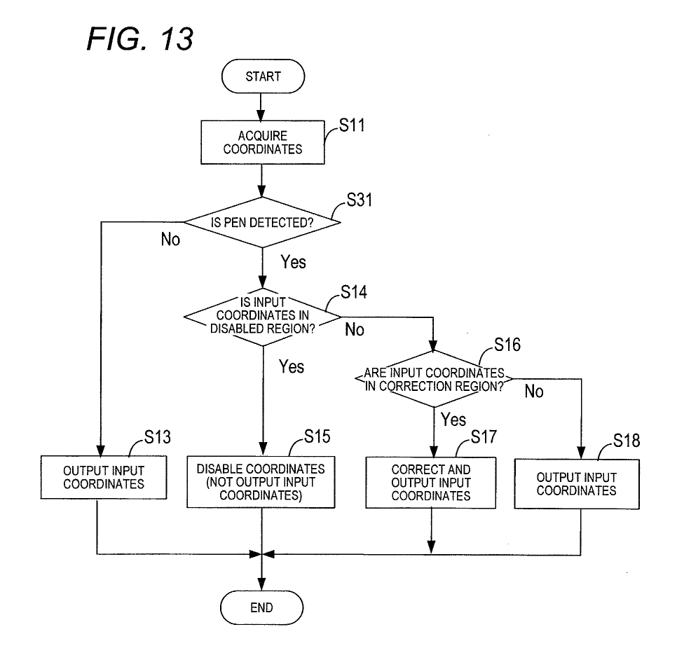

Next, an operation of the input device 10 is described. FIG. 13 is a flow chart showing an operation example of the input device 10. An input control program for performing this operation is stored in ROM within the input device 1C and executed by CPU within the input device 10. In FIG. 13, a description of the same steps as the steps described in FIG. 8 will be omitted or simplified.

After Step S11, the input means determination unit 31 determines whether the input means to perform the input to the touch panel 11 is a stylus pen or not (Step S31). When it is determined that the input means is not a stylus pen but a finger or the like having a relatively large input area, the process proceeds to Step S13. Meanwhile, when it is determined that the input means is a stylus pen, the process proceeds to Step S14.

Accordingly, when it is determined by the input means determination unit 31 that the input means is a stylus pen, the coordinate processing unit 15 is adapted to form the correction region D2 and the input disabled region D3 on the touch panel 21. And, the coordinate processing unit 15 performs the input disabling processing or the correction processing, depending on the input coordinates. On the contrary, when the input means is a finger, the whole of the touch panel 11 remains as the normal region D1 and therefore a normal input operation can be performed.

According to the input device 1C of the present embodiment, when the input means is a stylus pen, it is possible to prevent occurrence of an erroneous operation by the non-detection of the touch panel 11 by performing the disabling processing for the input to the end portion 11e of the touch panel 11. Further, it is possible to smoothly perform an input operation up to the end portion 11e of the touch panel 11 which becomes the input disabled region D3 by performing the correction processing. On the contrary, when the input means is a finger, it is possible to maintain the normal operability. Accordingly, it is possible to improve the operability of the touch panel 11 in which the end portion 11e is formed with the input disabled region D3.

Although the stylus pen is illustrated as an example of the input means in the present embodiment, the input means such as the stylus pen to be assumed in the present embodiment can include the means in which the input area to be detected by the touch panel 11 is relatively small.

The present invention is not limited to the configuration of the above embodiments but may have any other configurations, as long as the function defined in claim or the function provided in the configuration of the above embodiment can be achieved.

Further, the present invention may be applied to an input control program to realize the function of the above embodiments, which is supplied to the input device via a network or various storage mediums and read and executed by a computer in the input device.

Although the present invention has been described in detail with reference to particular illustrative embodiments, it is obvious to those skilled in the art that the illustrative embodiments can be variously modified without departing a spirit and a scope of the present invention.

This application is based upon Japanese Patent Application (Patent Application No. 2011-227261) filed on Oct. 14, 2011 and the contents of which are incorporated herein by reference.

### INDUSTRIAL APPLICABILITY

The present invention can be applied to an input device, an information terminal, an input control method and an input control program, which are capable of improving the operability of the touch panel including the end portion formed with a disabled region.

### DESCRIPTION OF REFERENCE SIGNS

1, 1B, 1C: Input Device

11, 21: Touch Panel

11e: End Portion of Touch Panel

21a: Touch Panel Surface

12: Coordinate Acquisition Unit

13: Gripping Determination Unit

14: Region Storage Unit

15: Coordinate Processing Unit

16: Control Unit

17: Display Processing Unit

18: Display Unit

22: Condition Determination Unit

31: Input Means Determination Unit

D1: Normal Region

D2, D2A, D2B, D2C: Correction Region

D3: Input Disabled Region

D4: Detectable Region

FG, FG1-FG5: Fingers

T1: Trajectory (Before Correction)

T2: Trajectory (After Correction)

1. An input device comprising:
a touch panel;
a coordinate detection unit which detects coordinates of input to the touch panel; and
a coordinate processing unit which performs a correction processing for input coordinates detected by the coordinate detection unit;
wherein, in the correction processing, the coordinate processing unit corrects first coordinates input to a correction region formed on an inner side of an end portion of the touch panel to second coordinates in an input disabled region formed within the end portion of the touch panel or in the correction region, based on a distance between the input disabled region and the first coordinates.

2. The input device according to claim 1,
wherein the coordinate processing unit performs the correction processing such that a distance between an edge of the touch panel and the second coordinates becomes shorter as the distance between the input disabled region and the first coordinates becomes shorter.

3. The input device according to claim 1,
wherein the coordinate processing unit corrects the first coordinates input to the correction region formed on a side of the end portion of the touch panel in a first direction to the second coordinates in the input disabled region formed on the end portion in the first direction or the correction region formed on the side of the end portion in the first direction.

4. The input device according to claim 1, further comprising a gripping determination unit which determines whether the input device is gripped,
wherein the coordinate processing unit forms the input disabled region and the correction unit when the gripping determination unit determines that the input device is gripped.

5. The input device according to claim 4,
wherein the coordinate processing unit forms the input disabled region and the correction region when the coordinate of the input to the touch panel in a direction perpendicular to a surface of the touch panel corresponds to coordinates in a predetermined range of non-contact with the touch panel.

6. The input device according to claim 1, further comprising an input means determination unit which determines whether input means for performing the input to the touch panel is a stylus pen,
wherein the coordinate processing unit forms the input disabled region and the correction region when the input means determination unit determines that the input means is the stylus pen.

7. The input device according to claim 1,
wherein the coordinate processing unit performs a disabling processing to disable third coordinates input to the input disabled region and also performs the correction processing.

8. An information terminal comprising the input device according to claim 1.

9. An input control method comprising:
detecting coordinates of input to a touch panel; and
performing a correction processing for detected input coordinates,
wherein, in the correction processing, first coordinates input to a correction region formed on an inner side of an end portion of the touch panel are corrected to second coordinates in an input disabled region formed within the end portion of the touch panel or in the correction region, based on a distance between the input disabled region and the first coordinates.

10. A non-transitory computer-readable medium storing an input control program comprising instructions, which when executed by a computer to execute each step of the input control method according to claim 9.
